(19) United States
(12) Patent Application Publication
(10) Pub. No.: US 2025/0029619 A1
(43) Pub. Date: Jan. 23, 2025

(54) AUTHENTICATION APPARATUS, AUTHENTICATION METHOD, AND RECORDING MEDIUM

(71) Applicant: NEC Corporation, Minato-ku, Tokyo (JP)

(72) Inventors: Ling GUO, Tokyo (JP); Hitoshi YAMAMOTO, Tokyo (JP)

(73) Assignee: NEC Corporation, Minato-ku, Tokyo (JP)

(21) Appl. No.: 18/686,492

(22) PCT Filed: Sep. 8, 2021
(86) PCT No.: PCT/JP2021/032947

§ 371 Date: Feb. 26, 2024

(51) Int. Cl. G10L 17/26; G10L 25/30

(52) U.S. Cl. CPC G10L 17/26; G10L 25/30

(57) ABSTRACT

An authentication apparatus includes: a calculation unit that calculates, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal, and that calculates a target feature quantity that is a feature quantity of the voice of the target person by combining the air conduction feature quantity and the bone conduction feature quantity; and an authentication unit that authenticates the target person on the basis of the target feature quantity.

### TECHNICAL FIELD

This disclosure relates, for example, to technical fields of an authentication apparatus, an authentication method, and a recording medium that are configured to authenticate a target person by using target person audio.

### BACKGROUND ART

Patent Literature 1 describes an example of an authentication apparatus that is configured to authenticate a target person by using a sound of the target person.

In addition, as prior art documents related to this disclosure, Patent Literature 2 to Patent Literature 4 are cited.

### CITATION LIST

### Patent Literature

Patent Literature 1: JP2006-011591A

Patent Literature 2: International Publication No. WO2018/034178A

Patent Literature 3: JP2007-017840A

Patent Literature 4: JP2006-010809A

### SUMMARY

### Technical Problem

It is an example object of this disclosure to provide an authentication apparatus, an authentication method, and a recording medium that are intended to improve the techniques/technologies described in Citation List.

### Solution to Problem

An authentication apparatus according to a first aspect of this disclosure includes: a calculation unit that calculates, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal, and that calculates a target feature quantity that is a feature quantity of the voice of the target person by combining the air conduction feature quantity and the bone conduction feature quantity; and an authentication unit that authenticates the target person on the basis of the target feature quantity.

An authentication apparatus according to a second aspect of this disclosure includes: a calculation unit that calculates, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and an authentication unit that authenticates the target person on the basis of the air conduction feature quantity and the different feature quantity.

An authentication method according to a first aspect of this disclosure includes: calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal; calculating a target feature quantity that is a feature quantity of the voice of the target person by combining the air conduction feature quantity and the bone conduction feature quantity; and authenticating the target person on the basis of the target feature quantity.

An authentication method according to a second aspect of this disclosure includes: calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and authenticating the target person on the basis of the air conduction feature quantity and the different feature quantity.

A recording medium according to a first aspect of this disclosure is a recording medium on which a computer program that allows a computer to execute an authentication method is recorded, the authentication method including: calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal; calculating a target feature quantity that is a feature quantity of the voice of the target person by combining the air conduction feature quantity and the bone conduction feature quantity; and authenticating the target person on the basis of the target feature quantity.

A recording medium according to a second aspect of this disclosure is a recording medium on which a computer program that allows a computer to execute an authentication method is recorded, the authentication method including: calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and authenticating the target person on the basis of the air conduction feature quantity and the different feature quantity.

### BRIEF DESCRIPTION OF DRAWINGS

FIG. 1 is a block diagram illustrating a configuration of an authentication apparatus according to a first example embodiment.

FIG. 2 is a block diagram illustrating a configuration of an authentication system in a second example embodiment.

FIG. 3 is a block diagram illustrating a configuration of an authentication apparatus according to the second example embodiment.

FIG. 4 is a flowchart illustrating a flow of a first authentication operation performed by the authentication apparatus according to the second example embodiment.

FIG. 5 is a block diagram illustrating a configuration of a calculation unit that performs the first authentication operation.

FIG. 6 is a flowchart illustrating a flow of a second authentication operation performed by the authentication apparatus according to the second example embodiment.

FIG. 7 is a block diagram illustrating configurations of a calculation unit and an authentication unit that perform the second authentication operation.

FIG. 8 is a block diagram illustrating a configuration of an authentication system in a third example embodiment.

FIG. 9 is a flowchart illustrating a flow of an authentication operation of authenticating a target person in view of a difference in position of bone conduction microphones.

### DESCRIPTION OF EXAMPLE EMBODIMENTS

Hereinafter, with reference to the drawings, an authentication apparatus, an authentication method, and a recording medium according to example embodiments will be described.

### (1) First Example Embodiment

First, an authentication apparatus, an authentication method, and a recording medium according to a first example embodiment will be described. The following describes the authentication apparatus, the authentication method, and the recording medium according to the first example embodiment, by using an authentication apparatus 1000 to which the authentication apparatus, the authentication method, and the recording medium according to the first example embodiment are applied.

FIG. 1 is a block diagram illustrating a configuration of the authentication apparatus 1000 according to the first example embodiment. As illustrated in FIG. 1, the authentication apparatus 1000 includes a calculation unit 1001 and an authentication unit 1002.

In a first example, the calculation unit 1001 calculates, from an air conduction sound signal indicating an air conduction sound of a voice of a target person (i.e., a voice/sound uttered by the target person, and the same shall apply hereinafter), an air conduction feature quantity that is a feature quantity of the air conduction sound signal. Furthermore, the calculation unit 1001 calculates, from a bone conduction sound signal indicating a bone conduction sound of the voice of the target person, a bone conduction feature quantity that is a feature quantity of the bone conduction sound signal. In addition, the calculation unit 1001 calculates a target feature quantity that is a feature quantity of the target person by combining the air conduction sound signal and the bone conduction feature quantity. The authentication unit 1002 authenticates the target person on the basis of the target feature quantity calculated by the calculation unit 1001.

As described above, in the first example, the authentication apparatus 1000 authenticates the target person not only on the basis of the air conduction feature quantity indicating the features of the voice of the target person, but also on the basis of the bone conduction feature quantity indicating the features of the voice of the target person on which an influence of a skeleton of the target person is superimposed (i.e., the bone conduction feature quantity that also indicates the features/characteristics of the skeleton of the target person). Therefore, as compared with an authentication apparatus that authenticates the target person on the basis of one of the air conduction feature quantity and the bone conduction feature quantity, the authentication apparatus 1000 is configured to authenticate the target person, more accurately, by using the voice of the 20 target person. In particular, the authentication apparatus 1000 may not separately perform a process of authenticating the target person on the basis of the air conduction feature quantity and a process of authenticating the target person on the basis of the bone conduction feature quantity that is different from the air conduction feature quantity. That is, the authentication apparatus 1000 may perform a process of authenticating the target person on the basis of the target feature 25 quantity that is calculated from the combined air conduction feature quantity and bone conduction feature quantity. Therefore, the authentication apparatus 1000 is capable of reducing a processing load for authenticating the target person.

On the other hand, in a second example, the calculation unit 1001 calculates, from the air 30 conduction sound signal indicating the air conduction sound of the voice of the target person and the bone conduction sound signal indicating the bone conduction sound of the voice of the target person, a difference feature quantity that is a feature quantity of a difference between a frequency spectrum of the air conduction sound signal and a frequency spectrum of the bone conduction sound signal. Furthermore, the calculation unit 1001 calculates, from the air conduction sound signal, the air conduction feature quantity that is the feature quantity of the air conduction sound signal. The authentication unit 1002 authenticates the target person on the basis of the air conduction feature quantity and the difference feature quantity.

Here, as described above, the air conduction feature quantity indicates the features of the voice of the target person. In addition, the difference feature quantity corresponds to a feature quantity obtained by substantially eliminating the features of the voice of the target person from the features of the voice of the target person on which the influence of the skeleton of the target person is superimposed. That is, the difference feature quantity corresponds to a feature quantity representing the features/characteristics of the skeleton of the target person indicating the individuality of the target person (i.e., the skeleton specific to the target person). For this reason, the authentication apparatus 1000 authenticates the target person on the basis of the air conduction feature quantity indicating the features of the voice of the target person and the difference feature quantity indicating the features/characteristics of the skeleton of the target person. As a consequence, as compared with an authentication apparatus that authenticates the target person on the basis of one of the air conduction feature quantity and the difference feature quantity, the authentication apparatus 1000 is configured to authenticate the target person, more accurately, by using the voice of the target person.

### (2) Second Example Embodiment

Next, an authentication apparatus, an authentication method, and a recording medium according to a second example embodiment will be described. The following describes the authentication apparatus, the authentication method, and the recording medium according to the second example embodiment, by using an authentication system SYS to which the authentication apparatus, the authentication method, and the recording medium according to the second example embodiment are applied.

### (2-1) Configuration of Authentication System SYS

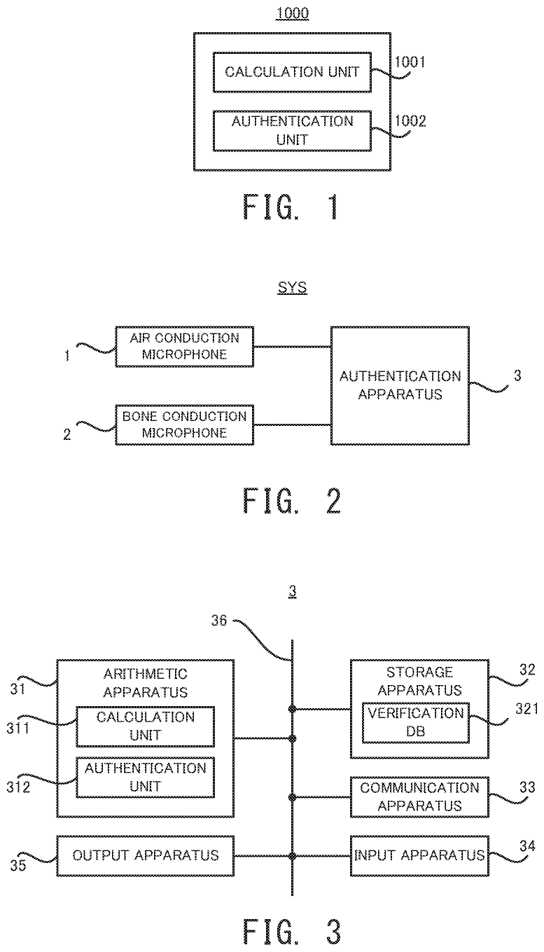

First, a configuration of the authentication system SYS according to the second example embodiment will be described with reference to FIG. 2. FIG. 2 is a block diagram illustrating the configuration of the authentication system SYS according to the second example embodiment.

As illustrated in FIG. 2, the authentication system SYS includes an air conduction microphone 1, a bone conduction microphone 2, and an authentication apparatus 3.

The air conduction microphone 1 is a sound detection apparatus that is configured to detect the air conduction sound of the voice of the target person. Specifically, it detects the vibration of air generated by the voice of the target person, thereby detect the air conduction sound of the voice of the target person. The air conduction microphone 1 detects the air conduction sound, thereby to generate a sound signal indicating the air conduction sound. In the following description, the sound signal indicating the air conduction sound is referred to as an “air conduction sound signal”. The air conduction microphone 1 outputs the generated air conduction sound signal to the authentication apparatus 3.

The bone conduction microphone 2 is a sound detection apparatus that is configured to detect the bone conduction sound of the voice of the target person. Specifically, it detects the vibration of the bones (skeleton) of the target person generated by the voice of the target person, thereby to detect the bone conduction sound of the voice of the target person. The bone conduction microphone 2 detects the bone conduction sound, thereby to generate a sound signal indicating the bone conduction sound. In the following description, the sound signal indicating the bone conduction sound is referred to as a “bone conduction sound signal”. The bone conduction microphone 2 outputs the generated bone conduction sound signal to the authentication apparatus 3.

The authentication apparatus 3 performs an authentication operation of authenticating the target person by using the voice of the target person. That is, the authentication apparatus 3 performs voice authentication. In order to perform the authentication operation, the authentication apparatus 3 acquires the air conduction sound signal from the air conduction microphone 1. In addition, the authentication apparatus 3 acquires the bone conduction sound signal from the bone conduction microphone 2. The authentication apparatus 3 then authenticates the target person by using the air conduction sound signal and the bone conduction sound signal.

An apparatus including the air conduction microphone 1, the bone conduction microphone 2, and the authentication apparatus 3 may be used as the authentication system SYS. For example, a portable terminal (e.g., a smartphone) that includes the air conduction microphone 1 and the bone conduction microphone 2 and that is capable of functioning as the authentication apparatus 3, may be used as the authentication system SYS. For example, a wearable device including the air conduction microphone 1, the bone conduction microphone 2, and the authentication apparatus 3 may be used as the authentication system SYS.

An exemplary situation where the authentication system SYS that performs the voice authentication is applied, is a situation where it is not easy to accurately perform face authentication and iris authentication. An exemplary situation where it is not easy to accurately perform face authentication and iris authentication, is a situation where the target person wearing a mask is to be authenticated. For example, the authentication system SYS may be used to manage the entry of a worker wearing a mask in at least one of a construction site and a factory. For example, the authentication system SYS may be used to manage the entry and exit of a medical worker wearing a mask in a medical facility. Another exemplary situation where the authentication system SYS that performs the voice authentication is applied, is a situation where it is not easy to accurately perform fingerprint authentication. An exemplary situation where it is not easy to accurately perform fingerprint authentication, is a situation where the target person wearing gloves is to be authenticated. For example, the authentication system SYS may be used to manage the entry and exit of a medical worker wearing gloves in a medical facility. Another exemplary situation where the authentication system SYS that performs the voice authentication is applied, is a situation where the target person is to be authenticated through a telephone service. The situations to which the authentication system SYS is applied, however, are not limited to those described here.

### (2-2) Configuration of Authentication Apparatus 3

Next, with reference to FIG. 3, a configuration of the authentication apparatus 3 in the second example embodiment will be described. FIG. 3 is a block diagram illustrating the configuration of the authentication apparatus 3 according to the second example embodiment.

As illustrated in FIG. 3, the authentication apparatus 3 includes an arithmetic apparatus 31 and a storage apparatus 32. In addition, the authentication apparatus 3 may include a communication apparatus 33, an input apparatus 34, and an output apparatus 35. The authentication apparatus 3, however, may not include at least one of the communication apparatus 33, the input apparatus 34, and the output apparatus 35. The arithmetic apparatus 31, the storage apparatus 32, the communication apparatus 33, the input apparatus 34, and the output apparatus 35 may be connected through a data bus 36.

The arithmetic apparatus 31 includes at least one of a CPU (Central Processing Unit), a GPU (Graphics Processing Unit), and a FPGA (Field Programmable Gate Array), for example. The arithmetic apparatus 31 reads a computer program. For example, the arithmetic apparatus 31 may read a computer program stored in the storage apparatus 32. For example, the arithmetic apparatus 31 may read a computer program stored by a computer-readable and non-transitory recording medium, by using a not-illustrated recording medium reading apparatus provided in the authentication apparatus 3 (e.g., the input apparatus 34 described later). The arithmetic apparatus 31 may acquire (i.e., download or read) a computer program from a not-illustrate apparatus disposed outside the authentication apparatus 3, through the communication apparatus 33 (or another communication apparatus). The arithmetic apparatus 31 executes the read computer program. Consequently, a logical functional block for performing an operation to be performed by the authentication apparatus 3 (e.g., the authentication operation described above) is realized or implemented in the arithmetic apparatus 31. That is, the arithmetic apparatus 31 is allowed to function as a controller for realizing or implementing the logical functional block for performing an operation (in other words, a process) to be performed by the authentication apparatus 3.

FIG. 3 illustrates an example of the logical functional block realized or implemented in the arithmetic apparatus 31 to perform the authentication operation. As illustrated in FIG. 3, a calculation unit 311 that is a specific example of the “calculation unit” and an authentication unit 312 that is a specific example of the “authentication unit” are realized or implemented in the arithmetic apparatus 31.

The calculation unit 311 calculates the target feature quantity that is the feature quantity of the target person used for the authentication operation, from the air conduction sound signal and the bone conduction sound signal. The target feature quantity calculated by the calculation unit 311 will be described in detail later.

The authentication unit 312 authenticates the target person on the basis of the target feature quantity calculated by the calculation unit 311. That is, the authentication unit 312 determines whether or not the target person matches a registered person on the basis of the target feature quantity calculated by the calculation unit 311. Specifically, a registration feature quantity that is a feature quantity about a voice of the registered person, is registered in advance in a verification DB (DataBase) 321 stored in the storage apparatus 32. In the verification DB 321, the registered feature quantities are registered for the number of the registered persons. The authentication unit 312 compares the target feature quantity calculated by the calculation unit 311 with the registration feature quantity registered in the verification DB 321, thereby to determine whether or not the target person matches the registered person.

The storage apparatus 32 is configured to store desired data. For example, the storage apparatus 32 may temporarily store a computer program to be executed by the arithmetic apparatus 31. The storage apparatus 32 may temporarily store data that are temporarily used by the arithmetic apparatus 31 when the arithmetic apparatus 31 executes the computer program. The storage apparatus 32 may store data that are stored by the authentication apparatus 3 for a long time. The storage apparatus 32 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 32 may include a non-transitory recording medium.

The communication apparatus 33 is configured to communicate with an apparatus external to the authentication apparatus 3, through a not-illustrated communication network. For example, the communication apparatus 33 may be communicable with at least one of the air conduction microphone 1 and the bone conduction microphone 2. In this instance, the communication apparatus 33 may receive (i.e., acquire) the air conduction sound signal from the air conduction microphone 1 through the not-illustrated communication network. The communication apparatus 33 may receive (i.e., acquire) the bone conduction sound signal from the bone conduction microphone 2 through the not-illustrated communication network.

The input apparatus 34 is an apparatus that receives an input of information to the authentication apparatus 3 from the outside of the authentication apparatus 3. For example, the input apparatus 34 may include an operating apparatus (e.g., at least one of a keyboard, a mouse, and a touch panel) that is operable by an operator of the authentication apparatus 3. For example, the input apparatus 34 may include a reading apparatus that is configured to read information recorded as data on a recording medium that can be externally attached to the authentication apparatus 3. For example, the input apparatus 34 may include an input interface through which at least one of the air conduction sound signal outputted from the air conduction microphone 1 and the bone conduction sound signal outputted from the bone conduction microphone 2 is inputted.

The output apparatus 35 is an apparatus that outputs information to the outside of the authentication apparatus 3. For example, the output apparatus 35 may output information as an image. That is, the output apparatus 35 may include a display apparatus (a so-called display) that is configured to display an image indicating the information that is desirably outputted. For example, the output apparatus 35 may output information as audio. That is, the output apparatus 35 may include an audio apparatus (a so-called speaker) that is configured to output the audio. For example, the output apparatus 35 may output information onto a paper surface. That is, the output apparatus 35 may include a print apparatus (a so-called printer) that is configured to print desired information on the paper surface.

### (2-3) Operation (Authentication Operation) of Authentication Apparatus 3

Next, a flow of the authentication operation performed by the authentication apparatus 3 according to the second example embodiment will be described. In the second example embodiment, the authentication apparatus 3 performs at least one of a first authentication operation and a second authentication operation. For this reason, the first authentication operation and the second authentication operation are described below in order.

### (2-3-1) First Authentication Operation

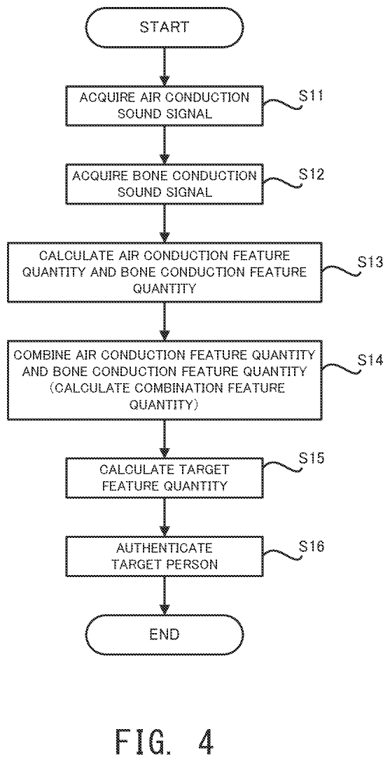

First, with reference to FIG. 4, a flow of the first authentication operation performed by the authentication apparatus 3 in the second example embodiment will be described. FIG. 4 is a flowchart illustrating the flow of the first authentication operation performed by the authentication apparatus 3 in the second example embodiment.

As illustrated in FIG. 4, the calculation unit 311 acquires the air conduction sound signal indicating the air conduction sound of the voice of the target person, from the air conduction microphone 1 (step S11). Furthermore, the calculation unit 311 acquires the bone conduction sound signal indicating the bone conduction sound of the voice of the target person, from the bone conduction microphone 2 (step S12).

Thereafter, the calculation unit 311 calculates the air conduction feature quantity that is the feature quantity of the air conduction sound signal, from the air conduction sound signal acquired in the step S11 (step S13). Furthermore, the calculation unit 311 calculates the bone conduction feature quantity that is the feature quantity of the bone conduction sound signal, from the bone conduction sound signal acquired in the step S12 (step S13).

The calculation unit 311 may calculate, as the air conduction feature quantity, an arbitrary parameter that qualitatively and/or quantitatively indicates the features of the air conduction sound signal. For example, the calculation unit 311 may perform a desired voice analysis process on the air conduction sound signal, thereby to calculate an arbitrary parameter indicating the features of the air conduction sound signal, as the air conduction feature quantity. An example of the desired voice analysis process is at least one of a frequency analysis process, a cepstral analysis process, and a pitch extraction process. An example of the arbitrary parameter indicating the features of the air conduction sound signal is a Mel Frequency Cepstrum Factor (MFCC) that can be calculated from a result of the frequency analysis process performed on the air conduction sound signal.

The air conduction feature quantity is an N-dimensional vector (i.e., a vector including N vector elements), where “N” is a constant indicating an integer of 1 or more. In this instance, the number of dimensions of the vector is preferably set to an appropriate number that allows the authentication operation to be properly performed. As an example, in a case where the mel frequency cepstral factor is used as the air conduction feature quantity, the air conduction feature quantity may be a vector of 12 or more dimensions.

Similarly, the calculation unit 311 may calculate, as the bone conduction feature quantity, an arbitrary parameter that qualitatively and/or quantitatively indicates the features of the bone conduction sound signal. For example, the calculation unit 311 may perform a desired voice analysis process on the bone conduction sound signal, thereby to calculate an arbitrary parameter indicating the features of the bone conduction sound signal, as the bone conduction feature quantity. An example of the arbitrary parameter indicating the features of the bone conduction sound signal is the mel frequency cepstral factor that can be calculated from the frequency analysis process performed on the bone conduction sound signal.

The bone conduction feature quality is an M-dimensional vector (i.e., a vector including M vector elements), where “M” is a constant indicating an integer of 1 or more. In this instance, the number of dimensions of the vector is preferably set to an appropriate number that allows the authentication operation to be properly performed. As an example, in a case where the mel frequency cepstral factor is used as the bone conduction feature quantity, the bone conduction feature quantity may be a vector of 12 or more dimensions.

Thereafter, the calculation unit 311 combines (in other words, connects or synthesizes) the air conduction feature quantity calculated in the step S13 and the bone conduction feature quantity calculated in the step S13 (step S14). As a result, the calculation unit 311 calculates a combination feature quantity that is a feature quantity of the combined air conduction feature quantity and bone conduction feature quantity (step S14).

As described above, since the air conduction feature quantity is an N-dimensional vector and the bone conduction feature quantity is an M-dimensional vector, the combination feature quantity is typically an N+M-dimensional vector. That is, the number of dimensions of the combination feature quantity is N+M. Conversely, the calculation unit 311 may calculate the combination feature quantity such that the combination feature quantity includes N vector elements included in the air conduction feature quantity and M vector elements included in the bone conduction feature quantity.

The combination feature quantity, however, may be a vector of less than N+M-dimensions. That is, the number of dimensions of the combination feature quantity may be less than N+M. The number of dimensions of the combination feature quantity, however, is greater than N and is greater than M. That is, the combination feature quantity may be a vector of less than N+M dimensions, greater than N dimensions, and greater than M dimensions. As an example, the calculation unit 311 may calculate the combination feature quantity such that the combination feature quantity includes at least one of N′ vector elements (where N′ is a constant indicating an integer of 1 or more and less than N) out of the N vector elements included in the air conduction feature quantity, and at least one of M′ vector elements (where M′ is a constant indicating an integer of 1 or more and less than M) out of the M vector elements included in the bone conduction feature quantity. That is, an operation of “calculating the combination feature quantity by combining the air conduction feature quantity and the bone conduction feature quantity” in the second example embodiment may mean an operation of “calculating the combination feature quantity such that the combination feature quantity includes at least one of the N vector elements included in the air conduction feature quantity and at least one of the M vector elements included in the bone conduction feature quantity.”

Thereafter, the calculation unit 311 calculates the target feature quantity to be used by the authentication unit 312 to perform the authentication operation, from the combination feature quantity calculated in step S14 (step S15). For example, the calculation unit 311 may extract a feature quantity indicating the features of the target person from the combination feature quantity calculated in the step S14, thereby to calculate the target feature quantity corresponding to the extracted feature quantity.

The calculation unit 311 may use a neural network that is configured to output the target feature quantity when the combination feature quantity is inputted, and that can be established by machine-learning, to calculate the target feature quantity from the combination feature quantity. The neural network may be established in advance, by machine-learning using teacher data including the air conduction sound signal of a sample person, the bone conduction sound signal of the sample person, and a correct answer label of a result of the authentication of the sample person.

Thereafter, the authentication unit 312 authenticates the target person on the basis of the target feature quantity calculated in the step S15 (step S16). Specifically, the authentication unit 312 calculates a degree of similarity between the target feature quantity calculated in the step S15 and the registration feature quantity corresponding to the registered person registered in the verification DB 321. The authentication unit 312 may determine that the target person matches the registered person when the calculated degree of similarity is greater than a predetermined authentication threshold (i.e., the target feature quantity is similar to the registration feature quantity). On the other hand, the authentication unit 312 may determine that the target person does not match the registered person when the calculated degree of similarity is less than the predetermined authentication threshold (i.e., the target feature quantity is not similar to the registration feature quantity).

The authentication unit 312 may use an arbitrary method for calculating the degree of similarity of the two feature quantities, to calculate the degree of similarity. The arbitrary method for calculating the degree of similarity of the two feature quantities may be a method using a Probabilistic Linear Discriminant Analysis (PLDA) model.

The authentication unit 312 may use the neural network to authenticate the target person. For example, the authentication unit 312 may use a neural network to which the probabilistic linear discriminant analysis model is applied, to authenticate the target person. The neural network may be established in advance, by machine-learning using teacher data including the air conduction sound signal of a sample person, the bone conduction sound signal of the sample person, and a correct answer label of a result of the authentication of the sample person.

As described above, in a case where the calculation unit 311 uses the neural network, the neural network used by the calculation unit 311 and the neural network used by the authentication unit 312 may be integrated. That is, the calculation unit 311 calculates the target feature quantity by using a first network part of the neural network, and the authentication unit 312 may authenticate the target person by using a second network part of the neural network to which an output of the first network part is inputted. In this instance, the neural network used by the calculation unit 311 and authentication unit 312 may be a neural network that conforms to a so-called x-vector (in other words, Deep Speaker Embedding).

In the verification DB 321, a plurality of registered feature quantities respectively corresponding to a plurality of registered persons may be registered. In this instance, by using the plurality of registered feature quantities, the authentication unit 312 may repeat an operation of determining whether or not the target person matches one registered person by calculating a degree of similarity between one registration feature quantity corresponding to the one registered person and the target feature quantity from the collation DB 321.

When the first authentication operation is performed, the registration feature quantity registered in the verification DB 321 may be generated in the same flow as that of the target feature quantity used in the first authentication operation. Specifically, in order to register the registration feature quantity in the collation DB 321, first, the air conduction sound signal indicating the air conduction sound of the voice of the registered person and the bone conduction sound signal indicating the bone conduction sound of the voice of the registered person may be acquired. After that, the air conduction feature quantity may be calculated from the air conduction sound signal, and the bone conduction feature quantity may be calculated from the bone conduction sound signal. Then, the combination feature quantity may be calculated by combining the air conduction feature quantity and the bone conduction feature quantity. After that, the registration feature quantity may be calculated from the combination feature quantity.

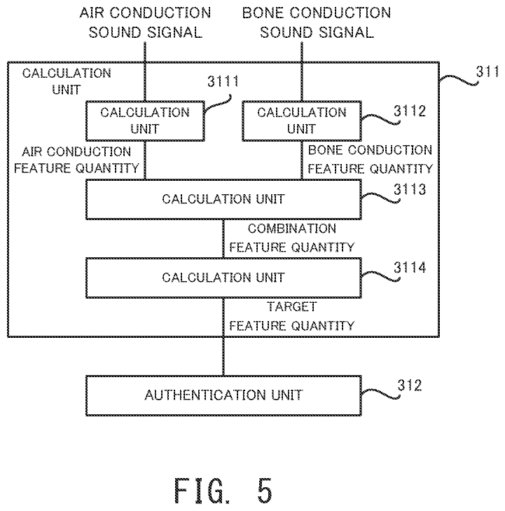

When the first authentication operation is performed in the flow illustrated in FIG. 4, the calculation unit 311 may include functional blocks illustrated in FIG. 5. Specifically, as illustrated in FIG. 5, the calculation unit 311 may include a calculation unit 3111, a calculation unit 3112, a calculation unit 3113, and a calculation unit 3114. The calculation unit 3111 may calculate the air conduction feature quantity from the air conduction sound signal. The calculation unit 3112 may calculate the bone conduction feature quantity from the bone conduction sound signal. The calculation unit 3113 may calculate the combination feature quantity by combining the air conduction feature quantity calculated by the calculation unit 3111 with the bone conduction feature quantity calculated by the calculation unit 3112. The calculation unit 3114 may calculate the target feature quantity from the combination feature quantity calculated by the calculation unit 3113.

According to the first authentication operation described above, the authentication apparatus 3 authenticates the target person not only on the basis of the air conduction feature quantity indicating the features of the voice of the target person, but also on the basis of the bone conduction feature quantity indicating the features of the voice of the target person on which the influence of the skeleton of the target person is superimposed (i.e., the bone conduction feature quantity that also indicates the features/characteristics of the skeleton of the target person). That is, the authentication apparatus 3 uses both the air conduction sound signal and the bone conduction sound signal, to authenticate the target person. Consequently, as compared with an authentication apparatus in a first comparative example that authenticates the target person on the basis of one of the air conduction sound signal and the bone conduction sound signal (i.e., that authenticates the target person on the basis of one of the air conduction sound signal and the bone conduction sound signal), the authentication apparatus 3 is configured to authenticate the target person, more accurately, by using the voice of the target person. That is, when the authentication apparatus in the first comparative example authenticates the target person on the basis of the air conduction feature quantity (i.e., does not use the bone conduction feature quantity to authenticate the target person), there may be a technical issue that authentication accuracy is likely reduced if an acquisition environment of the air conduction sound signal is not appropriate. For example, the authentication accuracy may be reduced when the acquisition environment of the air conduction sound signal is a noisy environment or an environment where the target person does not properly utter a sound. On the other hand, when the authentication apparatus in the first comparative example authenticates the target person on the basis the bone conduction feature quantity (i.e., does not use the air conduction feature quantity to authenticate the target person), there may be a technical issue that the authentication accuracy is likely reduced because accuracy of the bone conduction sound signal is lower than that of the air conduction sound signal in the first place. In the first authentication operation, however, the authentication apparatus 3 authenticates the target person on the basis of both the air conduction feature quantity and the bone conduction feature quantity. Therefore, the authentication apparatus 3 is capable of properly solving the technical issue that may occur in the authentication apparatus in the first comparative example.

Furthermore, according to the first authentication operation, the authentication apparatus 3 does not need to separately perform the process of authenticating the target person on the basis of the air conduction feature quantity, and the process of authenticating the target person on the basis of the bone conduction feature quantity that is different from the air conduction feature quantity. That is, the authentication apparatus 3 does not need to separately perform the two types of processes of respectively authenticating the target person on the basis of the two types of feature quantities. In other words, the authentication apparatus 3 may perform the process of authenticating the target person on the basis of one type of feature quantity that is the target feature quantity. Therefore, as compared with an authentication apparatus in a second comparative example that needs to separately perform the process of authenticating the target person on the basis of the air conduction feature quantity and the process of authenticating the target person on the basis of the bone conduction feature quantity, the authentication apparatus 3 is configured to reduce the number of times of execution of the process of authenticating the target person on the basis of the feature quantity (e.g., the number of times of calculation of the degree of similarity described above). As an example, the authentication apparatus 3 is capable of reducing the number of times that the authentication apparatus 3 performs the process of authenticating the target person on the basis of the feature quantity, to about half the number of times that the authentication apparatus in the second comparative example performs the process of authenticating the target person on the basis of the feature quantity. Consequently, the authentication apparatus 3 is capable of reducing the processing load for authenticating the target person.

In addition, the authentication apparatus 3 is configured to calculate the target feature quantity from the combination feature quantity, by using the neural network. Therefore, the authentication apparatus 3 is capable of calculating the target feature quantity, relatively easily, even when the combination feature quantity, which has a greater number of elements than that of each of the air conduction feature quantity and the bone conduction feature quantity, is used.

### (2-3-2) Second Authentication Operation

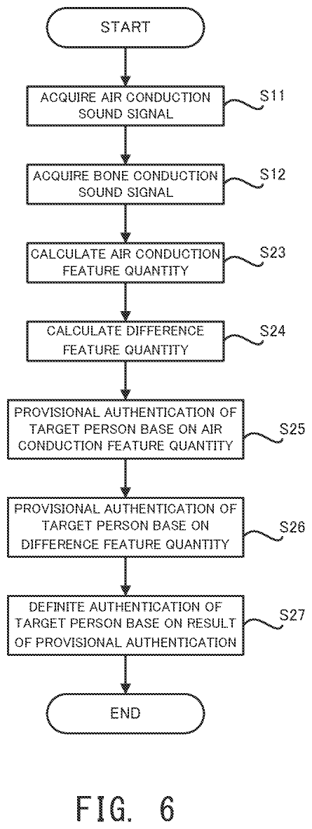

Next, with reference to FIG. 6, a flow of the second authentication operation performed by the authentication apparatus 3 in the second example embodiment will be described. FIG. 6 is a flowchart illustrating the flow of the second authentication operation performed by the authentication apparatus 3 in the second example embodiment.

As illustrated in FIG. 6, even in the second authentication operation, as in the first authentication operation, the calculation unit 311 acquires the air conduction sound signal from the air conduction microphone 1 (step S11). Furthermore, the calculation unit 311 acquires the bone conduction sound signal from the bone conduction microphone 2 (step S12).

Thereafter, even in the second authentication operation, as in the first authentication operation, the calculation unit 311 calculates the air conduction feature quantity from the air conduction sound signal acquired in the step S11 (step S23).

Meanwhile, in the second authentication operation, the calculation unit 311 does not need to calculate the bone conduction feature quantity from the bone conduction sound signal acquired in the step S12. In the second authentication operation, the calculation unit 311 calculates the difference feature quantity, instead of the bone conduction feature quantity (step S24). The difference feature quantity is a feature quantity indicating a difference between a frequency spectrum of the air conduction sound signal and a frequency spectrum of the bone conduction sound signal. (i.e., a feature quantity indicating the features of the difference). For example, the difference itself between the frequency spectrum of the air conduction sound signal and the frequency spectrum of the bone conduction sound signal may be used as the difference feature quantity. For example, a parameter calculated from the difference between the frequency spectrum of the air conduction sound signal and the frequency spectrum of the bone conduction sound signal may be used as the difference feature quantity. For example, a parameter that quantitatively or qualitatively indicates the difference between the frequency spectrum of the air conduction sound signal and the frequency spectrum of the bone conduction sound signal may be used as the difference feature quantity.

Thereafter, the authentication unit 312 authenticates the target person on the basis of the air conduction feature quantity calculated in the step S23 (step S25). Furthermore, the authentication unit 312 authenticates the target person on the basis of the difference feature quantity calculated in the step S24 (step S26). Therefore, in the second example embodiment, each of the air conduction feature quantity and the difference feature quantity is used as the target feature quantity actually used to authenticate the target person.

Even in the second authentication operation, as in the first authentication operation, the authentication unit 312 calculates the degree of similarity between the target feature quantity and the registration feature quantity registered in the verification DB 321, thereby to authenticate the target person. Here, as described above, in the second example embodiment, each of the air conduction feature quantity and the difference feature quantity is used as the target feature quantity. Therefore, in the second authentication operation, a first registration feature quantity corresponding to the air conduction feature quantity and a second registration feature quantity corresponding to the difference feature quantity are registered in the verification DB 321, as the registration feature quantity. The first registration feature quantity is a feature quantity of the air conduction sound signal indicating the air conduction sound of the voice of the registered person. The second registration feature quantity is a feature quantity indicating a difference between a frequency spectrum of the air conduction sound signal indicating the air conduction sound of the voice of the registered person and a frequency spectrum of the bone conduction sound signal indicating the bone conduction sound of the voice of the registered person. In this instance, the authentication unit 312 calculates a degree of similarity between the air conduction feature quantity calculated as the difference feature quantity in the step S23 and the first registration feature quantity registered in the verification DB 321, thereby to authenticate the target person in the step S25. In addition, the authentication unit 312 calculates a degree of similarity between the difference feature quantity calculated as the difference feature quantity in the step S24 and the second registration feature quantity registered in the verification DB 321, thereby to authenticate the target person in the step S26.

After that, the authentication unit 312 authenticates the target person on the basis of a result of the authentication of the target person in the step S25 and a result of the authentication of the target person in the step S26 (step S27). That is, in the second authentication operation, the authentication unit 312 provisionally authenticates the target person in each of the step S25 and the step S26, and deterministically (in other words, finally) authenticates the target person on the basis of a result of the provisional authentication in the step S27. As an example, the authentication unit 312 may determine that the target person matches one registered person, when it is determined that the target person matches one registered person in the step S25 and when it is determined that the target person matches the same one registered person in the step S26. On the other hand, the authentication unit 312 may determine that the target person does not match one registered person, when it is determined that the target person does not match one registered person in at least one of the step S25 and the step S26.

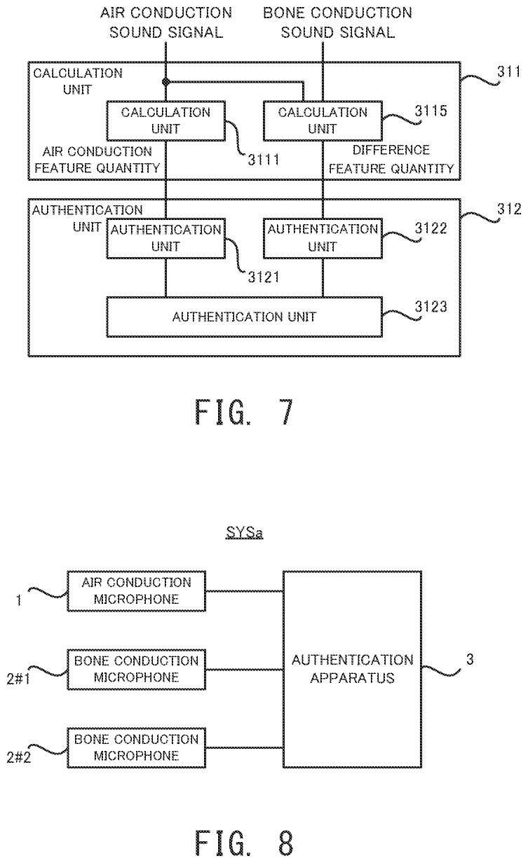

When the second authentication operation is performed in the flow illustrated in FIG. 6, the calculation unit 311 and the authentication unit 312 may include functional blocks illustrated in FIG. 7. Specifically, as illustrated in FIG. 7, the calculation unit 311 may include the calculation unit 3111 illustrated in FIG. 5 and a calculation unit 3115. The authentication unit 312 may include an authentication unit 3121, an authentication unit 3122, and an authentication unit 3123. The calculation unit 3111 may calculate the air conduction feature quantity from the air conduction sound signal as described above. The calculation unit 3115 may calculate the difference feature quantity from the air conduction sound signal and the bone conduction sound signal. The authentication unit 3121 may provisionally authenticate the target person on the basis of the air conduction feature quantity calculated by the calculation unit 3111. The authentication unit 3122 may provisionally authenticate the target person on the basis of the difference feature quantity calculated by the calculation unit 3115. The authentication unit 3123 may deterministically authenticate the target person on the basis of an authentication result of the authentication unit 3121 and an authentication result of the authentication unit 3122.

According to the second authentication operation described above, as in the first authentication operation, the authentication apparatus 3 uses both the air conduction sound signal and the bone conduction sound signal, to authenticate the target person. Consequently, as compared with the authentication apparatus in the first comparative example that authenticates the target person on the basis of one of the air conduction sound signal and the bone conduction sound signal, the authentication apparatus 3 is configured to authenticate the target person, more accurately, by using the voice of the target person.

In addition, according to the second authentication operation, the authentication apparatus 3 authenticates the target person on the basis of the difference feature quantity, instead of the bone conduction feature quantity. Here, the difference feature quantity corresponds to a feature quantity obtained by substantially eliminating the features of the voice of the target person from the features of the voice of the target person on which the influence of the skeleton of the target person is superimposed. That is, the difference feature quantity corresponds to a feature quantity representing the features/characteristics of the skeleton of the target person indicating the individuality of the target person (i.e., the skeleton specific to the target person). For this reason, the authentication apparatus 3 authenticates the target person on the basis of the air conduction feature quantity indicating the features of the voice of the target person and the difference feature quantity indicating the features/characteristics of the skeleton of the target person. As a consequence, as compared with an authentication apparatus in a third comparative example that authenticates the target person on the basis of one of the air conduction feature quantity and the difference feature quantity, the authentication apparatus 3 is configured to authenticate the target person, more accurately, by using the voice of the target person.

In addition, the authentication apparatus 3 deterministically authenticates the target person, on the basis of a result of the provisional authentication of the target person based on each of the air conduction feature quantity and the difference feature quantity. Therefore, as compared with in a case where the result of the authentication of the target person based on the air conduction feature quantity is used as a result of the deterministic authentication of the target person, or in a case where the result of the authentication of the target person based on the difference feature quantity is used as a result of the deterministic authentication of the target person, the authentication apparatus 3 is configured to authenticate the target person, more accurately, by using the voice of the target person.

### (3) Third Example Embodiment

Next, an authentication apparatus, an authentication method, and a recording medium according to a third example embodiment will be described. The following describes the authentication apparatus, the authentication method, and the recording medium according to the third example embodiment, by using an authentication system SYS to which the authentication apparatus, the authentication method, and the recording medium according to the third example embodiment are applied. In the following description, the authentication system SYS in the third example embodiment is referred to as an authentication system SYSa, and is thus distinguished from the authentication system SYS in the second example embodiment.

Hereinafter, with reference to FIG. 8, the authentication system SYSa according to the third example embodiment will be described. FIG. 8 is a block diagram illustrating a configuration of the authentication system SYSa according to the third example embodiment.

As illustrated in FIG. 8, the authentication system SYSa is different from the authentication system SYS in that it includes a plurality of bone conduction microphones 2. In the following description, as illustrated in FIG. 8, an example in which the authentication system SYSa includes two bone conduction microphones 2 (specifically, bone conduction microphones 2 #1 and 2 #2) will be described. Other features of the authentication system SYSa may be the same as those of the authentication system SYS.

The plurality of bone conduction microphones 2 are arranged at different positions with respective to the target person. For example, the bone conduction microphones 2 may be arranged to be respectively in contact with a plurality of different parts of the target person. As an example, the bone conduction microphone 2 #1 may be placed in contact with the head of the target person, and the bone conduction microphones 2 #2 may be placed in contact with the ear of the target person or in the vicinity. An example of the bone conduction microphone 2 #1 in contact with the head of the target person is a bone conduction microphone incorporated in an eyeglass-type wearable device (e.g., a temple part of eyeglasses). An example of the bone conduction microphone 2 #2 in contact with the ear of the target person or in the vicinity is a bone conduction microphone incorporated in a headset-type wearable device that can be worn on the ear of the target person.

A use of one of the plurality of bone conduction microphones 2 may be different from that of the other bone conduction microphone 2 that is different from the one of the plurality of bone conduction microphones 2. That is, the use of the bone conduction microphones 2 #1 may be different from the use of the bone conduction microphones 2 #2. As an example, one of the bone conduction microphones 2 #1 and 2 #2 may be used to calculate the registration feature quantity registered in the verification DB 321. In this instance, the registration feature quantity may be calculated from the bone conduction sound detected by one of the bone conduction microphones 2 #1 and 2 #2. On the other hand, the other of the bone conduction microphones 2 #1 and 2 #2 may be used to calculate the target feature quantity to authenticate the target person. In this case, the calculation unit 311 included in the authentication apparatus 3 described above may calculate the target feature quantity from the bone conduction sound detected by the other of the bone conduction microphones 2 #1 and 2 #2.

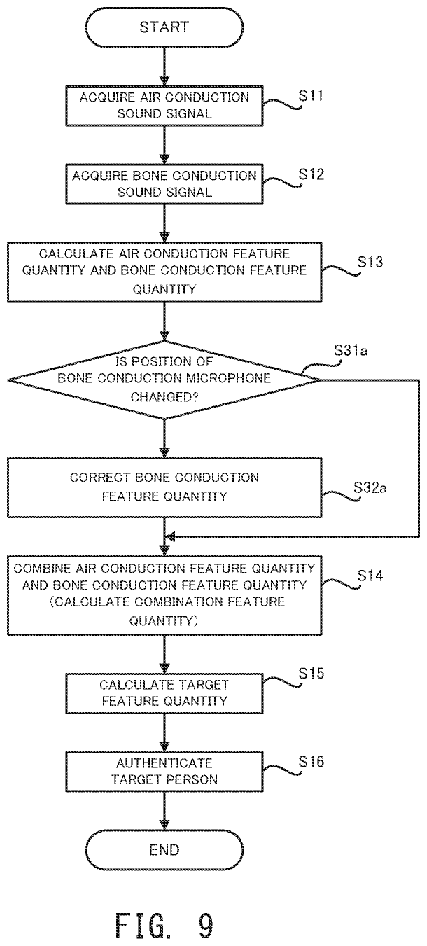

Here, the bone conduction sound detected by the bone conduction microphone 2 may vary depending on a detection position of the bone conduction sound. For example, the bone conduction sound (especially, its feature quantity) of one target person detected by the bone conduction microphone 2 disposed at one position may be different from the bone conduction sound (especially, its feature quantity) of the same target person detected by the bone conduction microphone 2 disposed at another position that is different from the one position. In this situation, the authentication accuracy of the authentication apparatus 3 may be reduced because the bone conduction microphone 2 for calculating the registration feature quantity is different from the bone conduction microphone 2 for calculating the target feature quantity. Therefore, the authentication unit 312 provided in the authentication apparatus 3 described above may authenticate the target person in view of a difference in the position of the bone conduction microphones 2. Hereinafter, the authentication operation of authenticating the target person in view of the difference in the position of the bone conduction microphones 2 will be described with reference to FIG. 9. FIG. 9) is a flowchart illustrating a flow of the authentication operation of authenticating the target person in view of the difference in the position of the bone conduction microphones.

As illustrated in FIG. 9, even in the third example embodiment, the calculation unit 311 acquires the air conduction sound signal (step S11), the calculation unit 311 acquires the bone conduction sound signal (step S12), and the calculation unit 311 calculates the air conduction feature quantity and the bone conduction feature quantity (step S13).

Thereafter, the authentication unit 312 determines whether or not the position of the bone conduction microphone 2 with respect to the target person is changed from the position when the registration feature quantity is calculated (step S31a). That is, the authentication unit 312 determines whether or not the position of the bone conduction microphone 2 used to calculate the registration feature quantity is different from the position of the bone conduction microphone 2 used to calculate the target feature quantity (i.e., the position of the bone conduction microphone 2 when the operation illustrated in FIG. 9 is performed, and the position of the bone conduction microphone 2 currently worn by the target person). In order to perform this determination, in the verification DB312, the registration feature quantity may be associated with microphone position information about the position of the bone conduction microphone 2 used to calculate the registration feature quantity. Consequently, the authentication unit 312 is capable of identifying the position of the bone conduction microphone 2 used to calculate the registration feature quantity, with reference to the verification DB312. Furthermore, information about the position of the bone conduction microphones 2 used to calculate the target feature quantity may be inputted to the authentication unit 312 by the target person, for example. Alternatively, the authentication unit 312 may estimate the position of the bone conduction microphone 2 currently worn by the target person (i.e., the position of the bone conduction microphone 2 used to calculate the target feature quantity) from a device number or the like of the bone conduction microphone 2 currently worn by the target person.

As a result of the determination in the step S31a, when it is determined that the position of the bone conduction microphone 2 is changed (i.e., the position of the bone conduction microphone 2 used to calculate the registration feature quantity is different from the position of the bone conduction microphone 2 used to calculate the target feature quantity (step S31a: Yes), the authentication unit 312 corrects the bone conduction feature quantity calculated in step S13 (step S32a). Specifically, the authentication unit 312 corrects the bone conduction feature quantity to cancel a change in the bone conduction feature quantity caused by the difference between the position of the bone conduction microphone 2 used to calculate the registration feature quantity and the position of the bone conduction microphone 2 currently worn by the target person. That is, the authentication unit 312 corrects the bone conduction feature quantity such that the bone conduction feature quantity after correction approaches (preferably matches) the bone conduction feature quantity calculated when it is assumed that the position of the bone conduction microphone 2 currently worn by the target person is the same as the position of the bone conduction microphone 2 used to calculate the registration feature quantity.

In order to correct the bone conduction feature quantity, a correction parameter for correcting the bone conduction feature quantity may be generated in advance from a difference between the feature quantity of the bone conduction sound actually detected by the bone conduction microphone 2 disposed at one position and the feature quantity of the bone conduction sound actually detected by the bone conduction microphone 2 disposed at another position that is different from the one position. For example, at least one of a correction parameter for correcting the feature quantity of the bone conduction sound detected by the bone conduction microphone 2 #1 to the feature quantity of the bone conduction sound detected by the bone conduction microphone 2 #2, and a correction parameter for correcting the feature quantity of the bone conduction sound detected by the bone conduction microphone 2 #2 to the feature quantity of the bone conduction sound detected by the bone conduction microphone 2 #1, may be generated in advance from a difference between the feature quantity of the bone conduction sound actually detected by the bone conduction microphone 2 #1 and the feature quantity of the bone conduction sound actually detected by the bone conduction microphone 2 #2. In this case, the authentication unit 312 may correct the bone conduction feature quantity by using the correction parameter.

On the other hand, as a result of the determination in the step S31a, when it is determined that the position of the bone conduction microphone 2 is not changed (i.e., the position of the bone conduction microphone 2 used to calculate the registration feature quantity is the same as the position of the bone conduction microphone 2 used to calculate the target feature quantity (step S31a: No), the authentication unit 312 does not need to correct the bone conduction feature quantity calculated in the step S13.

After that, even in the third example embodiment, the calculation unit 311 combines the air conduction feature quantity calculated in the step S13 with the bone conduction feature quantity calculated in the step S13 or corrected in the step S32a (step S14), the calculation unit 311 calculates the target feature quantity from the combination feature quantity (step S15), and the authentication unit 312 authenticates the target person on the basis of the target feature quantity (step S16).

According to the third example embodiment, the authentication apparatus 3 is configured to properly authenticate the target person, even when the position of the bone conduction microphone 2 used to calculate the registration feature quantity is different from the position of the bone conduction microphone 2 used to calculate the target feature quantity.

FIG. 9 illustrates the authentication operation that takes into account the difference in the position of the bone conduction microphones 2 in the first authentication operation described with reference to FIG. 4. The authentication apparatus 3, however, may also take into account the difference in the position of the bone conduction microphones 2, even when performing the second authentication operation described with reference to FIG. 6. That is, even when the authentication apparatus 3 performs the second authentication operation described with reference to FIG. 6, the bone conduction feature quantity may be corrected in view of the difference in the position of the bone conduction microphones 2.

### (4) Fourth Example Embodiment

Next, an authentication apparatus, an authentication method, and a recording medium according to a fourth example embodiment will be described. The following describes the authentication apparatus, the authentication method, and the recording medium according to the fourth example embodiment, by using an authentication system SYS to which the authentication apparatus, the authentication method, and the recording medium according to the fourth example embodiment are applied. In the following description, the authentication system SYS in the fourth example embodiment is referred to as an authentication system SYSb, and is thus distinguished from the authentication system SYS in the second example embodiment.

The authentication system SYSb is different from the authentication system SYS in that a part of the second authentication operation is different. Other features of the authentication system SYSb may be the same as those of the authentication system SYS.

Specifically, when performing the second authentication operation, the authentication apparatus 3 authenticates the target person on the basis of the air conduction feature quantity (step S25 in FIG. 6), and authenticates the target person on the basis of the difference feature quantity (step S26 in FIG. 6). In the fourth example embodiment, the authentication apparatus 3 estimates that there is some influence on the bone conduction feature quantity, when the degree of similarity between the air conduction feature quantity and the first registration feature quantity exceeds the authentication threshold (i.e., when it is determined that target person matches the registered person), while the degree of similarity between the difference feature quantity and the second registration feature quantity falls below the authentication threshold (i.e., while it is determined that the target person does not match the registered person). In this instance, the authentication apparatus 3 may correct the difference feature quantity. For example, the bone conduction features may vary depending on bone density. As an example, there is a possibility that the bone conduction feature quantity of a person with normal bone density is different from that of a person who suffers from osteoporosis. In this case, when the target person is determined to have osteoporosis, the authentication apparatus 3 may correct the difference feature quantity on the basis of information about a difference between the bone conduction feature quantity of the person with normal bone density and the bone conduction feature quantity of the person who suffers from osteoporosis. Consequently, the authentication apparatus 3 is capable of properly authenticating the target person even if there is some influence on the bone conduction feature quantity.

### (5) Fifth Example Embodiment

Next, an authentication apparatus, an authentication method, and a recording medium according to a fifth example embodiment will be described. The following describes the authentication apparatus, the authentication method, and the recording medium according to the fifth example embodiment, by using an authentication system SYS to which the authentication apparatus, the authentication method, and the recording medium according to the fifth example embodiment are applied. In the following description, the authentication system SYS in the fifth example embodiment is referred to as an authentication system SYSc, and is thus distinguished from the authentication system SYS in the second example embodiment.

The authentication system SYSc is different from the authentication system SYS in that it may perform a process of weighting the bone conduction feature quantity. Other features of authentication system SYSc may be the same as those of the authentication system SYS.

Specifically, the air conduction feature quantity is more easily influenced by an environmental sound around the target person than the bone conduction feature quantity is. Thus, when the environmental sound around the target person is relatively loud (e.g., loudness of the environmental sound is greater than a threshold), the weight of the bone conduction feature quantity may be increased as compared to otherwise. Specifically, in the first authentication operation, the authentication apparatus 3 may increase the weight of the bone conduction feature quantity when calculating the target feature quantity. In the second authentication operation, the authentication apparatus 3 may increase the weight of the bone conduction feature quantity (in this case, actually, the weight of the bone conduction sound signal) when calculating the difference feature quantity. Consequently, the authentication apparatus 3 is capable of properly authenticating the target person, even when the environmental sound around the target person is relatively loud.

### (6) Supplementary Notes

With respect to the example embodiment described above, the following Supplementary Notes are further disclosed.

### Supplementary Note 1

An authentication apparatus including:
a calculation unit that calculates, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal, and that calculates a target feature quantity that is a feature quantity of the voice of the target person by combining the air conduction feature quantity and the bone conduction feature quantity; and
an authentication unit that authenticates the target person on the basis of the target feature quantity.

### Supplementary Note 2

The authentication apparatus according to Supplementary Note 1, wherein the calculation unit calculates the target feature quantity by using a neural network that outputs the target feature quantity when the combined air conduction feature quantity and bone conduction feature quantity is inputted thereto.

### Supplementary Note 3

The authentication apparatus according to Supplementary Note 1 or 2, wherein
the calculation unit calculates a difference feature quantity that is a feature quantity of a difference between a frequency spectrum of the air conduction sound signal and a frequency spectrum of the bone conduction sound signal, and
the authentication unit that authenticates the target person on the basis of the air conduction feature quantity and the different feature quantity.

### Supplementary Note 4

An authentication apparatus including:
a calculation unit that calculates, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and
an authentication unit that authenticates the target person on the basis of the air conduction feature quantity and the different feature quantity.

### Supplementary Note 5

The authentication apparatus according to Supplementary Note 4, wherein the authentication unit performs a first process of provisionally authenticating the target person on the basis of the air conduction feature quantity and a second process of provisionally authenticating the target person on the basis of the difference feature quantity, and deterministically authenticates the target person on the basis of a result of the first process and a result of the second process.

### Supplementary Note 6

An authentication method including:
calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal;
calculating a target feature quantity that is a feature quantity of the voice of the target person by combining the air conduction feature quantity and the bone conduction feature quantity; and
authenticating the target person on the basis of the target feature quantity.

### Supplementary Note 7

An authentication method including:
calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and
authenticating the target person on the basis of the air conduction feature quantity and the different feature quantity.

### Supplementary Note 8

A recording medium on which a computer program that allows a computer to execute an authentication method is recorded, the authentication method including:
calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal;
calculating a target feature quantity that is a feature quantity of the voice of the target person by combining the air conduction feature quantity and the bone conduction feature quantity; and
authenticating the target person on the basis of the target feature quantity.

### Supplementary Note 9

A recording medium on which a computer program that allows a computer to execute an authentication method is recorded, the authentication method including:
calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and
authenticating the target person on the basis of the air conduction feature quantity and the different feature quantity.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is not limited to the examples described above and is allowed to be changed, if desired, without departing from the essence or spirit of this disclosure which can be read from the claims and the entire identification. An authentication apparatus, an authentication method, and a recording medium with such changes are also intended to be within the technical scope of this disclosure.

### DESCRIPTION OF REFERENCE CODES

SYS Authentication system
1 Air conduction microphone
2 Bone conduction microphone
3, 1000 Authentication apparatus
31 Arithmetic apparatus
311, 1001 Calculation unit
312, 1002 Authentication unit
32 Storage apparatus
321 Verification DB

What is claimed is:

1. An authentication apparatus comprising:
at least one memory configured to store instructions; and
at least one processor configured to execute the instructions to:
calculate, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal, and that calculates a target feature quantity that is a feature quantity of the voice of the target person by combining the air conduction feature quantity and the bone conduction feature quantity; and
authenticate the target person on the basis of the target feature quantity.

2. The authentication apparatus according to claim 1, wherein the at least one processor is configured to execute the instructions to calculate the target feature quantity by using a neural network that outputs the target feature quantity when the combined air conduction feature quantity and bone conduction feature quantity is inputted thereto.

3. The authentication apparatus according to claim 1, wherein
the at least one processor is configured to execute the instructions to calculate a difference feature quantity that is a feature quantity of a difference between a frequency spectrum of the air conduction sound signal and a frequency spectrum of the bone conduction sound signal, and
the at least one processor is configured to execute the instructions to authenticate the target person on the basis of the air conduction feature quantity and the different feature quantity.

4. An authentication apparatus comprising:
the at least one processor is configured to execute the instructions to calculate, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a difference feature quantity that is a feature quantity of a difference between a frequency spectrum of the air conduction sound signal and a frequency spectrum of the bone conduction sound signal; and
the at least one processor is configured to execute the instructions to authenticate the target person on the basis of the air conduction feature quantity and the different feature quantity.

5. The authentication apparatus according to claim 4, wherein the at least one processor is configured to perform a first process of provisionally authenticating the target person on the basis of the air conduction feature quantity and a second process of provisionally authenticating the target person on the basis of the difference feature quantity, and deterministically authenticates the target person on the basis of a result of the first process and a result of the second process.

6. An authentication method comprising:
calculating, from an air conduction sound signal indicating an air conduction sound of a voice of a target person and a bone conduction sound signal indicating a bone conduction sound of the voice of the target person, an air conduction feature quantity that is a feature quantity of the air conduction sound signal and a bone conduction feature quantity that is a feature quantity of the bone conduction sound signal;
calculating a target feature quantity that is a feature quantity of the voice of the target person by combining the air conduction feature quantity and the bone conduction feature quantity; and
authenticating the target person on the basis of the target feature quantity.

7.-9. (canceled)
